(19) United States
(12) Patent Application Publication
(10) Pub. No.: US 2021/0365078 A1
(43) Pub. Date: Nov. 25, 2021

(54) FOLDING APPARATUS AND FLEXIBLE ELECTRONIC DEVICE

(71) Applicant: Shenzhen Royole Technologies Co., Ltd., Shenzhen (CN)

(72) Inventors: Songya Chen, Shenzhen (CN); Zhuping Hong, Shenzhen (CN); Xiaofei Fan, Shenzhen (CN); Wenjun Liu, Shenzhen (CN); Shuai Su, Shenzhen (CN)

(21) Appl. No.: 17/326,428

(22) Filed: May 21, 2021

(30) Foreign Application Priority Data
May 22, 2020 (CN) 202010443585.X

(51) Int. Cl. G06F 1/16; E05D 3/12; E05F 5/06; E05D 11/10; E05D 3/18

(52) U.S. Cl. CPC G06F 1/1681; E05D 3/122; E05F 5/06; E05Y 2800/244; E05D 3/18; E05Y 2900/606; E05D 11/10

(57) ABSTRACT

The present disclosure provides a folding apparatus and a flexible electronic device. The folding apparatus includes a hinge module, at least one linkage mechanism, and at least one low-temperature self-locking mechanism. The linkage mechanism is connected to the hinge module and configured to drive the hinge module to bend synchronously, so as to synchronously bend the folding apparatus. When an ambient temperature is lower than a safe temperature, the low-temperature self-locking mechanism implements self-locking matching between the linkage mechanism and the hinge module to restrict a synchronous bending of the hinge module driven by the linkage mechanism, and then the folding apparatus is restricted from bending synchronously, so that the self-locking protection of the folding apparatus under the ambient temperature is achieved. The flexible electronic device is restricted from bending when the ambient temperature is lower than the safe temperature, and the flexible electronic device is protected from damage.

### CROSS-REFERENCE TO RELATED APPLICATIONS

The present application claims priority of Chinese Patent Application No. 202010443585.X, filed on May 22, 2020, in China National Intellectual Property Administration, the contents of which are herein incorporated by reference in its entirety.

### FIELD

The present disclosure relates to the technical field of flexible folding devices, and in particular, to a folding apparatus and a flexible electronic device.

### BACKGROUND

With the development of display devices, bendable flexible electronic devices now have come into people's lives. The flexible electronic device is provided with a flexible display screen and a corresponding folding apparatus. Compared with a conventional straight panel-type electronic device, the electronic device using the flexible display screen has the advantages of being foldable and flexible, and is deeply favored by consumers.

However, the flexible display screen is a physical lamination formed by bonding a plurality of layers through optical adhesive. When the flexible display screen is placed in an environment below a certain ambient temperature, for example, in an environment with a temperature of zero degree centigrade or lower, the elasticity modulus, resilience, and creep properties of the optical adhesive and the multiple layers would all drop sharply. Furthermore, the bending resistance of the flexible display screen also decreases accordingly, which deteriorates the mechanical relationship in a flexible display device and is not suitable for flexible deformation. If a bending operation is performed at this ambient temperature, the flexible display screen would be damaged, which seriously affects usage experience of a user in a low-temperature environment.

### SUMMARY

An embodiment of the present disclosure provides a folding apparatus including: a hinge module; at least one linkage mechanism connected to the hinge module and configured to drive the hinge module to bend synchronously; and at least one low-temperature self-locking mechanism, where when an ambient temperature is lower than a safe temperature, the low-temperature self-locking mechanism implements self-locking matching between the linkage mechanism and the hinge module to restrict a synchronous bending of the hinge module driven by the linkage mechanism.

Another embodiment of the present disclosure provides a flexible electronic device including the folding apparatus above.

### BRIEF DESCRIPTION OF THE DRAWINGS

To describe technical solutions in embodiments of the present disclosure more clearly, the following briefly describes the accompanying drawings required for describing the embodiments. It should be understood that the following accompanying drawings show merely some embodiments of the present disclosure, and therefore should not be regarded as a limitation on the scope. A person of ordinary skill in the art may still derive other related accompanying drawings from these accompanying drawings without creative efforts.

FIG. 1 shows a schematic diagram of a stereo structure of a folding apparatus according to the present disclosure.

FIG. 2 shows a schematic diagram of a partially exploded structure of the folding apparatus in FIG. 1.

FIG. 3 shows a schematic diagram of an exploded structure of an intermediate hinge section assembly in a hinge module according to the present disclosure.

FIG. 4 shows a schematic diagram of a modularized exploded structure of the folding apparatus in FIG. 1.

FIG. 5 shows a schematic structural diagram of a linkage mechanism in the folding apparatus according to the present disclosure.

FIG. 6 shows a schematic diagram of a partial enlarged structure at portion A in FIG. 1.

FIG. 7 shows a schematic diagram of a partial enlarged structure at portion B in FIG. 4.

FIG. 8 shows an exploded view of a low-temperature self-locking mechanism in the folding apparatus according to the present disclosure.

FIG. 9 shows a schematic structural diagram of a linkage sliding block in the low-temperature self-locking mechanism according to the present disclosure;

FIG. 10 shows a schematic structural diagram of the folding apparatus according to the present disclosure after bending.

FIG. 11 shows a cross-sectional view taken along line C-C in FIG. 10.

FIG. 12 shows a cross-sectional view taken along line D-D in FIG. 10.

FIG. 13 shows a schematic diagram of a partial enlarged structure at portion E in FIG. 11.

FIG. 14 shows a schematic structural diagram of removal of a mounting plate after the folding apparatus according to the present disclosure is bent.

FIG. 15 shows a partial enlarged schematic diagram at portion F in FIG. 14.

### DETAILED DESCRIPTION

Embodiments of the present disclosure will be described in detail below. Examples of the embodiments are shown in the accompanying drawings, in which the same or similar reference numerals refer to the same or similar elements or elements having the same or similar functions throughout. The embodiments described below by referring to the accompanying drawings are examples and are merely intended to explain the present disclosure, and cannot be understood as limiting the present disclosure.

In the description of the present disclosure, it should be understood that the orientation or positional relationships indicated by the terms “center”, “longitudinal”, “transverse”, “length”, “width”, “thickness”, “up”, “down”, “front”, “rear”, “left”, “right”, “vertical”, “horizontal”, “top”, “bottom”, “inner”, “outer”, “clockwise”, “counterclockwise”, “axial”, “radial”, “circumferential”, and so on are based on orientation or positional relationships shown in the accompanying drawings. It is only for the convenience of describing the present disclosure and simplifying the description, and does not indicate or imply that the referred apparatus or element must have a specific orientation and be constructed and operated in a specific orientation. Therefore, it cannot be understood as limiting the present disclosure.

Moreover, the terms such as “first” and “second” are used only for the purpose of description and cannot be understood as indicating or implying relative importance or implicitly indicating the number of technical features indicated. Thus, features defined with “first” and “second” may explicitly or implicitly include one or more of the features. In the description of the present disclosure, “a plurality of” means two or more, unless otherwise specifically defined.

In the present disclosure, unless otherwise specified and defined, the terms such as “mount”, “connected with”, “connected to” and “fix” and so on should be comprehended in a broad sense. For example, these terms may be comprehended as being fixedly connected, detachably connected or integrally connected; or mechanically connected, or electrically connected; or directly connected, or indirectly connected through an intermediate medium, or in an internal communication between two elements or an interactive relationship between two elements. A person of ordinary skill in the art may understand specific meanings of the foregoing terms in the present disclosure based on a specific situation.

In the present disclosure, unless otherwise specified and limited, a first component being “on” or “beneath” a second component means that the first component is in direct contact with the second component, or the first component is in indirect contact with the second component through an intermediate medium. Furthermore, if the first component is “above” the second component, it means that the first component is over or obliquely above the second component, or only means that the level of the first component is greater than that of the second component. If the first component is “below” the second component, it means that the first component is under or obliquely below the second component, or only means that the level of the first component is less than that of the second component.

### First Embodiment

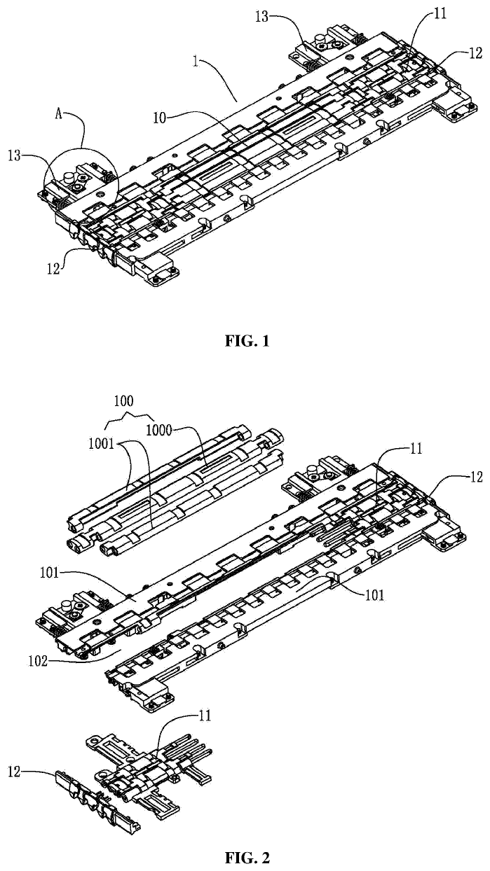

Referring to FIG. 1 and FIG. 2, a folding apparatus 1 provided in this embodiment includes a hinge module 10, at least one linkage mechanism 11, and at least one low-temperature self-locking mechanism 14 (see FIG. 4). The linkage mechanism 11 is connected to the hinge module 10 and configured to drive the hinge module 10 to bend synchronously.

When an ambient temperature is lower than a safe temperature, the low-temperature self-locking mechanism 14 implements self-locking matching between the linkage mechanism 11 and the hinge module 10 to restrict the linkage mechanism 11 from driving the hinge module 10 to bend synchronously, restricting the bending and flattening of the folding apparatus 1, and implementing self-locking protection at the low temperature.

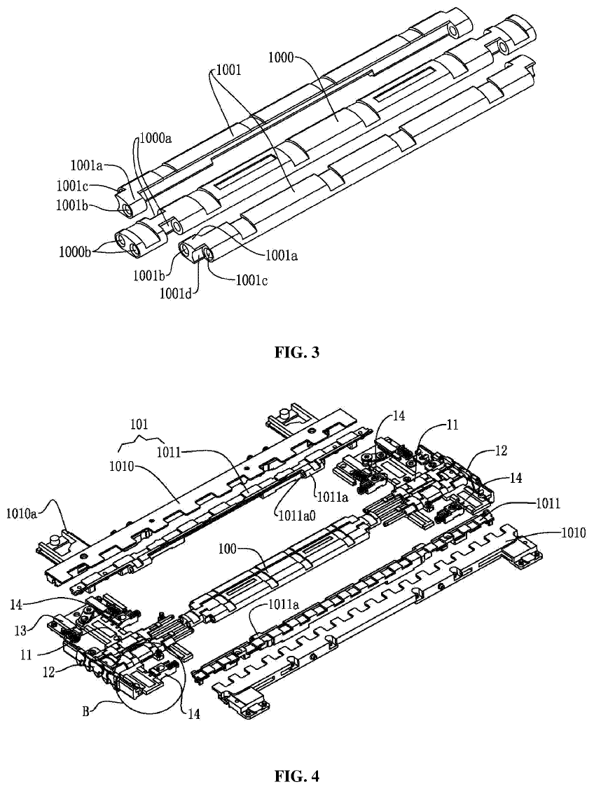

Also referring to FIG. 3 and FIG. 4, specifically, the hinge module 10 includes: an intermediate hinge section assembly 100 located in the middle portion and connecting hinge sections 101 respectively connected to two opposite sides of the intermediate hinge section assembly 100; in other words, there are two connecting hinge sections 101, and the two connecting hinge sections 101 are connected to two sides of the intermediate hinge section assembly 100.

Specifically referring to FIG. 3, the intermediate hinge section assembly 100 is located in the middle portion of the hinge module 10. The intermediate hinge section assembly 100 includes a fixed hinge section 1000 disposed in the middle and at least one movable hinge section 1001 disposed on two sides of the fixed hinge section 1000, respectively. In other words, the two sides of the fixed hinge section 1000 are each provided with at least one movable hinge section 1001.

In this embodiment, as shown in FIG. 3, the two sides of the fixed hinge section 1000 are each provided with one movable hinge section 1001, and the two movable hinge sections 1001 are symmetrically disposed and respectively rotatably connected to the fixed hinge section 1000. The two movable hinge sections 1001 are respectively matched with an arc surface of the fixed hinge section 1000 to avoid interferences when the two movable hinge sections 1001 rotate relative to the fixed hinge section 1000, and make the mounting structure more compact at the same time.

The fixed hinge section 1000 is elongated, and symmetrical first mounting notches 1000a are both provided at positions of the fixed hinge section 1000 close to two ends. Two end faces of the fixed hinge section 1000 are each provided with a pair of first shaft holes 1000b, and the first shaft holes 1000b extend toward the inside of the fixed hinge section 1000 in a length direction of the fixed hinge section 1000, and penetrate through the corresponding first mounting notches 1000a, respectively. It can be understood that two end faces of the fixed hinge section 1000 are each opened with a pair of first shaft holes 1000b, and the first shaft holes 1000b are in one-to-one correspondence with the first mounting notches 1000a.

A first convex head 1001a adapted to the first mounting notch 1000a is convexly disposed on one side of each of both ends of the two movable hinge sections 1001 facing the fixed hinge section 1000. In a length direction of the movable hinge section 1001, the first convex head 1001a is opened with a first through hole 1001b adapted to the first shaft hole 1000b. One side of each of two ends of the two movable hinge sections 1001 facing away from the first convex head 1001a is provided with a second mounting notch 1001d, and the second mounting notch 1001d is opened with a second shaft hole 1001c. The second shaft hole 1001c extends toward the inside of the movable hinge section 1001 in the length direction of the movable hinge section 1001.

As shown in FIG. 1, FIG. 2 and FIG. 4, two connecting hinge sections 101 are rotatably connected to the corresponding movable hinge sections 1001, respectively. Moreover, the connecting hinge sections 101 are matched with the arc surfaces of the corresponding movable hinge sections 1001 respectively to avoid interferences and make the mounting more compact.

The two connecting hinge sections 101 each include a hinge section body member 1011 and a mounting plate 1010. The hinge section body member 1011 is elongated. The hinge section body member 1011 has a length greater than the movable hinge section 1001, and the mounting plate 1010 and the hinge section body member 1011 are slidably assembled together.

A second convex head 1011a is convexly disposed on the side of the hinge section body member 1011 facing the movable hinge section 1001 close to the second mounting notch 1001d. The second convex head 1011a is adapted to the second mounting notch 1001d. The second convex head 1011a is opened with a second through hole 1011a0 in a length direction of the hinge section body member 1011, and the second through hole 1011a0 corresponds to the second shaft hole 1001c opened in the second mounting notch 1001d.

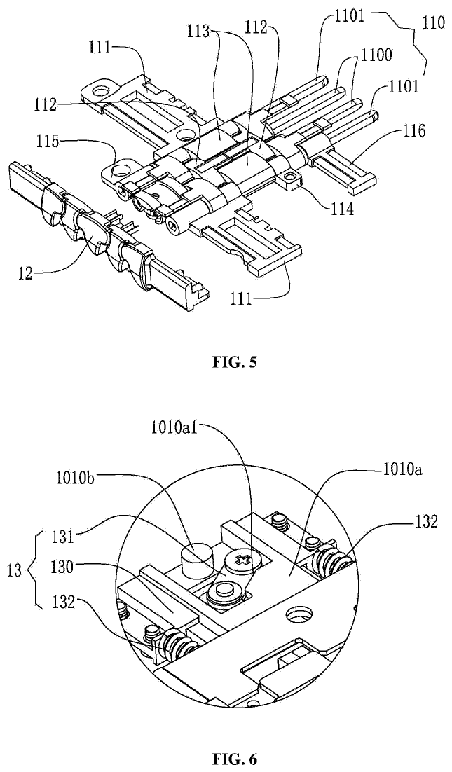

Referring to FIG. 1, FIG. 2, FIG. 4, and FIG. 5, two linkage mechanisms 11 are provided in this embodiment. The two linkage mechanisms 11 are disposed at two opposite ends of the intermediate hinge section assembly 100, respectively, and the two linkage mechanisms 11 are respectively disposed in an accommodating region 102 formed between the connecting hinge section 101 and the intermediate hinge section assembly 100. This design method can effectively reduce the overall thickness and width of the folding apparatus 1. The two linkage mechanisms 11 are respectively connected to the intermediate hinge section assembly 100 and the connecting hinge sections 101 located on both sides.

Specifically referring to FIG. 5, the two linkage mechanisms 11 each include four articulated shafts 110, two connecting rod members 111, and a linkage gear assembly. The four articulated shafts 110 are disposed parallel to each other, and are partially designed as a flat structure. The four articulated shafts 110 are respectively two first articulated shafts 1100 and two second articulated shafts 1101. The two first articulated shafts 1100 are located between the two second articulated shafts 1101. The linkage gear assembly implements synchronous action of the four articulated shafts 110 and the two connecting rod members 111. In the process of unfolding or bending the folding apparatus 1, the connecting hinge sections 101 on both sides bend synchronously under the linkage action of the linkage gear assembly.

The two first articulated shafts 1100 are disposed corresponding to the fixed hinge section 1000, and assembled in the corresponding first shaft hole 1000b and first shaft hole 1001b, respectively, so as to rotatably assemble the movable hinge section 1001 and the fixed hinge section 1000. The two second articulated shafts 1101 are disposed corresponding to the movable hinge sections 1001 respectively and assembled in the corresponding second shaft hole 1001c and the second through hole 1011a0, so as make the connecting hinge section 101 rotate relative to the movable hinge section 1001 on the same side.

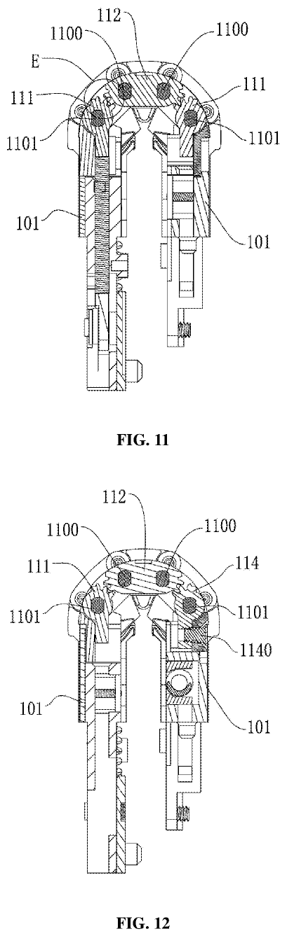

Referring to FIG. 2, FIG. 4, FIG. 5, and FIG. 11, one end of each of the two connecting rod members 111 is respectively assembled on one of the second articulated shafts 1101 on both sides. As shown in FIG. 11, one of the connecting rod members 111 is selected for description below, and the connecting rod member 111 is in anti-rotation matching with the corresponding second articulated shaft 1101. In other words, the connecting rod member 111 rotates synchronously with the second articulated shaft 1101.

The other end of the connecting rod member 111 extends in the connecting hinge section 101 on the same side, and can slide relative to the connecting hinge section 101. It can be understood that, when the connecting rod member 111 rotates synchronously with the second articulated shaft 1101, the connecting rod member 111 relatively slides in the connecting hinge section 101, and synchronously drives the connecting hinge section 101 to rotate around the movable hinge section 1001 at the same time.

In this embodiment, as shown in FIG. 5, the connecting rod member 111 on the left is closer to the intermediate hinge section assembly 100 than the connecting rod member 111 on the right. In other words, the two connecting rod members 111 are disposed oppositely disposed in a staggered manner.

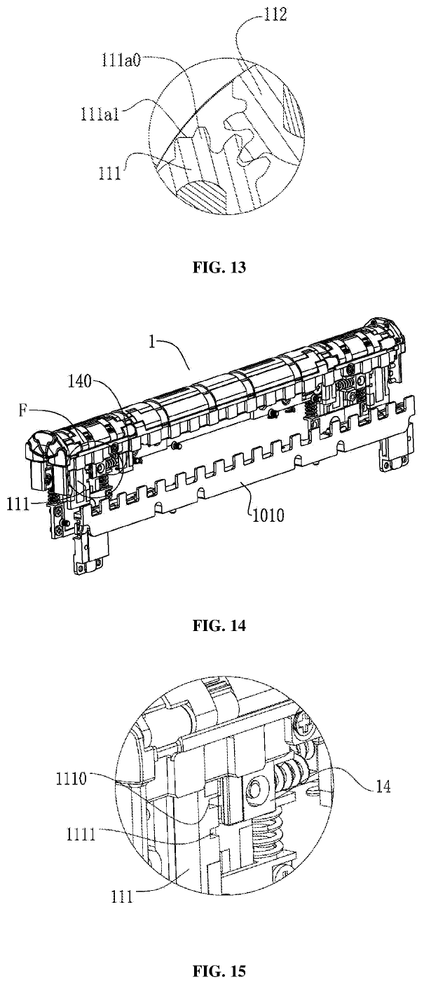

Also referring to FIG. 10, FIG. 11, FIG. 12, and FIG. 13, the linkage gear assembly includes a pair of linkage gears 112 assembled on the two first articulated shafts 1100 in the middle, and the pair of linkage gears 112 is in meshing transmission with the connecting rod members 111 at two ends respectively through an incomplete gear structure. It can be understood that the connecting rod member 111 is provided with a predetermined number of convex teeth 111a0 meshing with the linkage gear 112.

When the hinge module 10 is converted from a bent state to a flattened state, the linkage gear 112 drives the connecting rod members 111 on both sides to rotate, and the rotation direction is the flattening rotation direction. As shown in FIG. 11 or FIG. 12, the flattening rotation direction of the connecting rod member 111 on the left is clockwise, and the flattening rotating direction of the connecting rod member 111 on the right is counterclockwise.

Specifically referring to FIG. 11, FIG. 12 and FIG. 13, the connecting rod member 111 is further provided with a flattened tooth 111a1 in the flattening rotation direction close to a last convex tooth 111a0 after flattening. As shown in FIG. 13, it can be understood that the flattened tooth 111a1 is in adjacent contact with the convex tooth 111a0. The tooth top of the flattened tooth 111a1 is designed as a plane structure. When the folding apparatus 1 is being flattened, the flattened tooth 111a1 fits the tooth top of the convex tooth 111a0 correspondingly disposed on the linkage gear 112 to form a surface fit, and the connecting rod member 111 and the linkage gear 112 abut against each other, so that the connecting rod member 111 is restricted from continuing to rotate in the flattening rotation direction. The linkage mechanism 11 can no longer drive the hinge module 10 to bend synchronously. At this time, the folding apparatus 1 has been flattened. The arrangement of the structure of the flattened tooth 111a1 enables the flattening protection of the folding apparatus 1.

Also referring to FIG. 5, the linkage mechanism 11 further includes a first connecting rod auxiliary part 114, and the first connecting rod auxiliary part 114 and the connecting rod member 111 on the right in FIG. 5 are disposed on the same side; that is, the first connecting rod auxiliary part 114 is assembled on the second articulated shaft 1101 on the right, the first connecting rod auxiliary part 114 is closer to an end of the intermediate hinge section assembly 100 than the connecting rod member 111, and one end of the first connecting rod auxiliary part 114 toward the linkage gear 112 is in meshing transmission with the corresponding linkage gear 112 through an incomplete gear structure. In the same way, the first connecting rod auxiliary part 114 is also provided with a flattened tooth 111a1 structure consistent with that on the connecting rod member 111 to implement the flattening protection of the folding apparatus 1.

A pair of damping elements 113 is disposed between the pair of linkage gears 112. The pair of damping elements 113 is symmetrically disposed, and each of the damping elements 113 is assembled on one first articulated shaft 1100 and one second articulated shaft 1101 to provide rotational resistance, with the purpose of increasing the rotational resistance of the hinge module 10 to slow down the rotational speed of the hinge module 10, further improving safety, protecting the device from damage, and improving user experience.

In this embodiment, the two connecting rod members 111 are further inserted into the hinge section body member 1011 and the mounting plate 1010 on the same side respectively, and the first connecting rod auxiliary part 114 is inserted in the hinge section body member 1011 on the same side. In FIG. 5, the connecting rod member 111 on the left is fixedly connected with the hinge section body member 1011 by a screw 1140. The connecting rod member 111 can relatively slide in the mounting plate 1010, so that the connecting rod member 111 drives the mounting plate 1010 on the left to slide on the hinge section body member 1011. In FIG. 5, the connecting rod member 111 on the right can slide relative to the hinge section body member 1011 and the mounting plate 1010 on the same side, and the first connecting rod auxiliary part 114 is fixedly connected to the hinge section body member 1011 on the side through a screw 1140, so that the connecting rod member 111 drives the mounting plate 1010 on the right to slide on the hinge section body member 1011.

One side of the connecting rod member 111 away from the intermediate hinge section assembly 100 is further provided with a second connecting rod auxiliary part 115, and the second connecting rod auxiliary part 115 is assembled, with the connecting rod member 111 on the left in FIG. 5, in a hinged manner on the second articulated shaft 1101 on the same side and is fixedly connected to the hinge section body member 1011 on the side through a screw 1140. One side of the first connecting rod auxiliary part 114 away from the connecting rod member 111 is further provided with a third connecting rod auxiliary part 116, and the third connecting rod auxiliary part 116 is assembled on the second articulated shaft 1101 on the same side with the first connecting rod auxiliary part 114, extends into the hinge section body member 1011 and the mounting plate 1010 on the same side, and can slide relative to the hinge section body member 1011 and the mounting plate 1010. The second connecting rod auxiliary part 115 and the third connecting rod auxiliary part 116 are disposed to ensure that the linkage mechanism 11 is more stable and reliable in action.

Further, one end of each of the two linkage mechanisms 11 disposed in the accommodating region 102 away from the intermediate hinge section assembly 100 is provided with a decorative chain 12 assembly. The decorative chain 12 assembly rotates with the linkage mechanism 11 and the two do not interfere with each other. The decorative chain 12 assembly plays a role of decoration and protection, and is configured to protect the linkage mechanism 11 and the hinge module 10, so as to increase the service life of the folding apparatus 1.

Referring to FIG. 1, FIG. 4, FIG. 5 and FIG. 6, in some embodiments of the present disclosure, the folding apparatus 1 further includes two buffer mechanisms 13, and the two buffer mechanisms 13 respectively correspond to the connecting rod member 111 on the left in FIG. 5. One of the two buffer mechanisms 13 is selected for description below. The buffer mechanism 13 is disposed at an end of the connecting rod member 111 away from the linkage gear 112. The buffer mechanism 13 includes a buffer connecting plate 130 and a positioning connecting piece 131. The buffer connecting plate 130 is elastically connected to the mounting plate 1010 through a pair of spring members 132, where the buffer connecting plate 130 is slidably assembled with a bump 1010a disposed on the mounting plate 1010, and an accommodating groove (not shown) in sliding fit with the connecting rod member 111 is formed after the assembly. One end of the positioning connecting piece 131 is rotatably mounted in the accommodating groove, and the other end thereof is rotatably connected, through an elongated hole, to an end of the connecting rod member 111 extending in the accommodating groove.

When the folding apparatus 1 is bent, the connecting rod member 111 slides retractably in the accommodating groove, that is, the connecting rod member 111 pulls the positioning connecting piece 131, and the positioning connecting piece 131 is in contact with and limits a limiting surface 1010a1 on the mounting plate 1010, so that the connecting rod member 111 is retractably and slidably limited in the accommodating groove, and the buffer connecting plate 130 compresses the spring member 132 at the same time. When the folding apparatus 1 is flattened, the connecting rod member 111 slides in the accommodating groove in a protruding manner, that is, the connecting rod member 111 pushes the positioning connecting piece 131, and the positioning connecting piece 131 is in contact with and limits the limiting post 1010b of the mounting plate 1010 disposed relative to the limiting surface 1010a1, so that the connecting rod member 111 is slidably limited in a protruding manner in the accommodating groove, and the buffer connecting plate 130 stretches the spring member 132. In this way, the buffer connecting plate 130 can be prevented from collapsing on the mounting plate 1010 during a fall, so as to protect a component fixedly connected to the buffer connecting plate 130 from damage.

In some embodiments of the present disclosure, certainly, the same buffer mechanism 13 may be disposed on one side of the connecting rod member 111 on the right in FIG. 5.

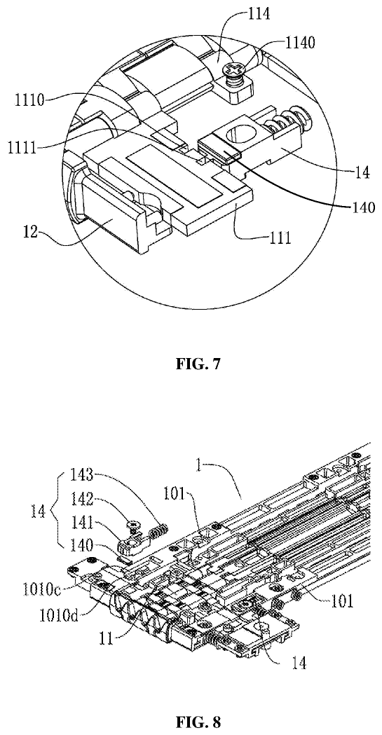

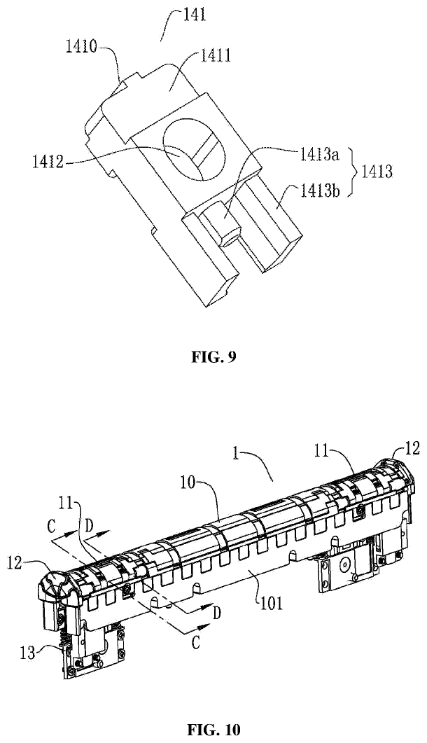

Referring to FIG. 4, FIG. 7, FIG. 8 and FIG. 9, the low-temperature self-locking mechanisms 14 are respectively disposed for a connecting rod member 111 to match the corresponding connecting rod member 111, so as to implement the self-locking matching between the linkage mechanism 11 and the hinge module 10. The low-temperature self-locking mechanisms 14 each include an elastic member 143, a linkage sliding block 141, and a low-temperature shrinking member 140.

In this embodiment, one of the low-temperature self-locking mechanisms 14 is selected for description. The linkage sliding block 141 is slidably mounted in the mounting plate 1010 of the connecting hinge section 101, and the sliding direction of the linkage sliding block 141 is toward or away from the direction of the connecting rod member 111. A sliding groove 1010c adapted to the linkage sliding block 141 is further provided in a position of the mounting plate 1010 corresponding to the linkage sliding block 141, and the linkage sliding block 141 can selectively slide toward the connecting rod member 111 in the sliding groove 1010c.

The elastic member 143 is disposed on one side of the linkage sliding rod 141 away from the connecting rod member 111 to drive the linkage sliding block 141 to slide in the sliding groove 1010c. One end of the linkage sliding block 141 facing the elastic member 143 is provided with a guide member 1413 that matches the elastic member 143. The guide member 1413 includes a positioning post 1413a and positioning stops 1413b disposed on both sides of the positioning post 1413a. One end of the elastic member 143 is connected to a side wall of the sliding groove 1010c, the other end thereof is sleeved on the positioning post 1413a. The positioning post 1413a can guide and position the elastic member 143. The two positioning stops 1413b have a length greater than the positioning post 1413a, and a space for accommodating the elastic member 143 is formed between the two positioning stops 1413b, to further guide and position the elastic member 143 and prevent the elastic member 143 from being disengaged.

In some embodiments of the present disclosure, the elastic member 143 is always in a state of being compressed by the linkage sliding block 141 in the sliding groove 1010c. In other words, the linkage sliding block 141 always maintains the compression of the elastic member 143, and the elastic member 143 stores deformation energy. In addition, because the elastic member 143 needs to recover from deformation, a certain thrust on the linkage sliding block 141 is always maintained, so that the linkage sliding block 141 maintains a tendency to slide towards the connecting rod member 111 and is configured to abut against the connecting rod member 111.

In some embodiments of the present disclosure, the elastic member 143 includes one of a spring or an elastic sheet. In this embodiment, the elastic member 143 is a spring.

The linkage sliding block 141 is configured to abut against a convex point 1410 of the connecting rod member 111 with one end provided with a protrusion, and one side of the connecting rod member 111 corresponding to the convex point 1410 is opened with a first clamping groove 1110 and a second clamping groove 1111 which are adapted to the convex point 1410. The convex point 1410 is configured to match the first clamping groove 1110 or the second clamping groove 1111, so as to restrict the relative sliding of the connecting rod member 111 in the connecting hinge section 101.

It can be understood that the first clamping groove 1110 or the second clamping groove 1111 match the convex point 1410 in shape, and the convex point 1410 is pushed into the first clamping groove 1110 or the second clamping groove 1111 to achieve the purpose of restricting the connecting rod member 111.

In some embodiments of the present disclosure, the convex point 1410 is selectively designed as a square, arc-shaped or cylindrical convex point 1410, where the arc includes a spherical segment, and the first clamping groove 1110 and the second clamping groove 1111 should be adapted to the convex point 1410 in shape.

In this embodiment, the convex point 1410 is designed into a square, and the first clamping groove 1110 and the second clamping groove 1111 are correspondingly designed as square clamping grooves. The first clamping groove 1110 and the second clamping groove 1111 are separated by a predetermined distance, and the distance is determined according to a bending angle of a bending apparatus, and the first clamping groove 1110 is closer to the linkage mechanism 11 than the second clamping groove 1111. In other words, the first clamping groove 1110 is located inside the second clamping groove 1111.

The low-temperature shrinking member 140 is disposed at one end of the linkage sliding block 141 close to the connecting rod member 111, one end of the low-temperature shrinking member 140 abuts against the linkage sliding block 141, and the other end thereof is toward the connecting rod member 111.

The low-temperature shrinking member 140 is a temperature-sensing element having the characteristics of thermal expansion and cold shrinking. In other words, the low-temperature shrinking member 140 has a first shape when the ambient temperature is lower than the safe temperature, that is, below the safe temperature, and the first shape is a shrinked state. The low-temperature shrinking member 140 has a second shape when the ambient temperature is higher than the safe temperature, that is, above the safe temperature, and the second shape is an expanded state.

Further, the low-temperature shrinking member 140 expands or shrinks along the sliding direction of the linkage sliding block 141. Specifically, when the ambient temperature is below the safe temperature, the low-temperature shrinking member 140 has a first length in the sliding direction of the linkage sliding block after shrinking, and when the ambient temperature is above the safe temperature, the low-temperature shrinking member 140 has a second length in the sliding direction of the linkage sliding block after expansion. It can be understood that the first length is less than the second length.

The low-temperature shrinking member 140 having the first length is not enough to abut against the connecting rod member 111. In this case, the linkage sliding block 141 slides towards the connecting rod member 111 under the drive of the elastic member 143. At the same time, the convex point 1410 matches the first clamping groove 1110 or the second clamping groove 1111 to restrict the sliding of the connecting rod member 111.

The low-temperature shrinking member 140 having the second length can directly abut against the connecting rod member 111 to drive the linkage sliding block 141 to slide away from the connecting rod member 111, or prevent the linkage sliding block 141 from sliding towards the connecting rod member 111. At the same time, the linkage sliding block 141 compresses the elastic member 143, such that the convex point 1410 disengages from the first clamping groove 1110 or the second clamping groove 1111. In other words, the linkage sliding block 141 removes restrictions on the sliding of the connecting rod member 111.

In this embodiment, a state of the convex point 1410 after matching with the first clamping groove 1110 or the second clamping groove 1111 is a low-temperature protection state. In the same way, a state after the convex point 1410 is disengaged from the first clamping groove 1110 or the second clamping groove 1111 is a free state.

When the ambient temperature in which the low-temperature shrinking member 140 is located rises from below the safe temperature to above the safe temperature, the connecting rod member 111 is converted from the low-temperature protection state to the free state accordingly, that is, the low-temperature protection state is removed.

In this embodiment, as shown in FIG. 4, FIG. 7, FIG. 14, and FIG. 15, in the process of bending the folding apparatus 1 to the bent state, the connecting rod member 111 rotates, under the meshing of the linkage gear 112, around the second articulated shaft 1101 in the direction opposite to the flattening direction, and slides in an extending-in manner relative to the connecting hinge section 101. When the folding apparatus 1 reaches a bent state, the connecting rod member 111 stops action accordingly. At this time, the first clamping groove 1110 corresponds to the convex point 1410 of the linkage sliding block 141. Similarly, when the folding apparatus 1 is in the flattened state, the connecting rod member 111 rotates in the flattening direction, the connecting rod member 111 retractably slides in the reverse direction in the connecting hinge section 101, and the second clamping groove 1111 corresponds to the convex point 1410 of the linkage sliding block 141.

In some embodiments of the present disclosure, the low-temperature self-locking mechanism 14 further includes a limiting member 142, where the limiting member 142 is mounted on the mounting plate 1010; and the limiting member 142 is configured to restrict the linkage sliding block 141 from being disengaged from the sliding groove 1010c.

In this embodiment, the limiting member 142 is disposed corresponding to the sliding groove 1010c on the mounting plate 1010. Specifically, a middle portion of the linkage sliding block 141 is opened with a strip-shaped guide hole 1412. The length direction of the strip-shaped guide hole 1412 is the same as that of the linkage sliding block 141. One end of the limiting member 142 penetrates through the strip-shaped guide hole 1412 and is detachably connected to the bottom of the sliding groove 1010c. The size of a fixed end of the limiting member 142 is greater than the width of the strip-shaped guide hole 1412 to restrict the linkage sliding block 141 from being disengaged from the sliding groove 1010c.

In some embodiments of the present disclosure, the limiting member 142 is in an adjustable threaded connection with the bottom of the sliding groove 1010c. The state of matching between the limiting member 142 and the sliding groove 1010c can be adjusted through tightening and loosening, so that the tightness of the linkage sliding block 141 mounted in the sliding groove 1010c can be further adjusted, and the sliding sensitivity is adjusted.

It should be noted that, the limiting member 142 restricts the axial movement of the linkage sliding block 141, and also plays another role, that is, to prevent the axial expansion of the low-temperature shrinking member 140, so that when the low-temperature shrinking member 140 is heated, the expansion direction of the low-temperature shrinking member 140 is directional; that is, it expands in the plane of the sliding direction of the linkage sliding block 141, which is more beneficial to guiding the convex point 1410 on the linkage sliding block 141 into the first clamping groove 1110 or the second clamping groove 1111.

In some embodiments of the present disclosure, a guide post 1010d adapted to the strip-shaped guide hole 1412 extends at the bottom of the sliding groove 1010c, and the matching between the strip-shaped guide hole 1412 and the guide post 1010d is used to limit the sliding direction of the linkage sliding block 141. The limiting member 142 is detachably mounted on the guide post 1010d, and the above-mentioned objective can also be achieved by adopting an adjustable threaded connection method.

In some embodiments of the present disclosure, certainly, when the diameter of the guide post 1010d and the width of the strip-shaped guide hole 1412 are in clearance fit, its function can replace that of the sliding groove 1010c.

In some embodiments of the present disclosure, a step 1411 is concavely disposed at one side of the linkage sliding block 141 facing the sliding groove 1010c, the step 1411 is disposed close to the connecting rod member 111, and the low-temperature shrinking member 140 is movably disposed in a chamber between the step 1411 and the sliding groove 1010c.

Further, in some embodiments of the present disclosure, one end of the low-temperature shrinking member 140 may be connected to a side wall of the step 1411, so that the low-temperature shrinking member 140 abuts against the linkage sliding block 141, and the low-temperature shrinking member 140 has a height flush with or lower than that of the step 1411, to prevent the low-temperature shrinking member 140 from expanding in a plane where the vertical linkage sliding block slides, so as to ensure that the linkage sliding block 141 slides more smoothly.

In some embodiments of the present disclosure, the low-temperature shrinking member 140 is made of a memory alloy material. The memory alloy material includes one or more of a titanium-nickel-aluminum-vanadium alloy, a copper-aluminum-manganese alloy, a titanium-nickel-chromium alloy, or a nickel-titanium-iron alloy.

In some embodiments of the present disclosure, the low-temperature shrinking member 140 may be made of polymer non-metallic materials or composites with low temperature and high shrinkage.

With reference to FIGS. 1 to 15, the low-temperature self-locking mechanism 14 and a self-locking function of the low-temperature self-locking mechanism 14 are realized as follows.

First state: when the ambient temperature is above the safe temperature and the folding apparatus 1 is in a flattened or bent state, the low-temperature shrinking member 140 is an expanded state and has a second length.

At the second length, the low-temperature shrinking members 140 abut against the corresponding connecting rod members 111 and the linkage sliding blocks 141 respectively, the connecting rod members 111 respectively exert an opposite acting force to the low-temperature shrinking member 140, and the opposite acting force drives the linkage sliding block 141 to overcome the elastic force of the elastic member 143, so as to prevent the linkage sliding block 141 from sliding toward the first clamping groove 1110 or the second clamping groove 1111 under the elastic force of the elastic member 143. The linkage sliding block 141 in this state removes the restriction on the sliding of the corresponding connecting rod member 111. The connecting rod member 111 can slide freely relative to the mounting plate 1010. Furthermore, the linkage mechanism 11 can be in linkage with the movable hinge sections 1001 on both sides of the fixed hinge section 1000 and the connecting hinge section 101 to rotate synchronously, such that the folding apparatus 1 can freely complete the bending or flattening.

Second state: when the ambient temperature is lower than the safe temperature and the folding apparatus 1 is a flattened or bent state, the low-temperature shrinking member 140 is a shrinked state and has a second length.

At the first length, the low-temperature shrinking members 140 remove the abutting against the corresponding connecting rod members 111 respectively, and the elastic member 143 converts the stored deformation energy into a reaction force against the linkage sliding block 141. Driven by the reaction force, the linkage sliding blocks 141 slide toward the corresponding connecting rod members 111 respectively. Since the second length is not enough to abut against the connecting rod member 111 and the linkage sliding block 141 at the same time, the linkage sliding block 141 is driven by the reaction force of the elastic member 143, so that the linkage sliding block 141 slides toward the connecting rod member 111, which realizes the self-control matching at the low temperature. It can be understood that, when the ambient temperature is lower than the safe temperature, and when the folding apparatus 1 is in a flattened state, the convex point 1410 is pushed into the corresponding second clamping groove 1111. When the ambient temperature is lower than the safe temperature, and when the folding apparatus 1 is in the bent state, the convex point 1410 is pushed into the first clamping groove 1110. The relative sliding of the connecting rod member 111 in the mounting plate 1010 is restricted. At this time, the linkage mechanism 11 is in a self-locking protection state, and the movable hinge sections 1001 on both sides of the fixed hinge section 1000 and the connecting hinge section 101 cannot be rotated. Therefore, the folding apparatus 1 cannot be bent or flattened under the low-temperature self-locking protection.

The folding apparatus 1 in this embodiment utilizes the thermal expansion and shrinking characteristics of the low-temperature shrinking member 140 to realize that when the ambient temperature is lower than a safe temperature; that is, in a low-temperature environment, the low-temperature self-locking mechanism 14 implements self-locking matching between the linkage mechanism 11 and the hinge module 10, which restricts the linkage mechanism 11 from driving the hinge module 10 to bend synchronously, so that the folding apparatus 1 is restricted from bending or flattening, achieving the low-temperature self-locking protection of the folding apparatus 1 at the ambient temperature. An electronic device with the folding apparatus 1 is further protected from bending in a low temperature environment, so as to protect the electronic device from damage.

In addition, the low-temperature self-locking mechanism 14 in this embodiment is different from a conventional low-temperature detection technology. The present application restricts the bending at the low temperature by using the physical properties of thermal expansion and shrinking of the low-temperature shrinking member 140 and the property that the linkage mechanism 11 slides while rotating relative to the hinge module 10, without adding redundant sensing apparatuses or signal transmission mechanisms, simplifying the electronic circuit structure.

### Second Embodiment

A folding apparatus 1 in this embodiment is an improvement made on the basis of the technical solution of the first embodiment, and for the unimproved solution, the technical solution of the first embodiment continues to be used. The specific improvements are as follows: In this embodiment, a low-temperature self-locking mechanism 14 only includes a low-temperature shrinking member 140, and a connecting rod member 111 is not provided with a first clamping groove 1110 and a second clamping groove 1111.

For illustrative purposes only, the low-temperature shrinking member 140 may be disposed adjacent to the corresponding connecting rod member 111. When the temperature in which the low-temperature shrinking member 140 is located is lower than a safe temperature, since the low-temperature shrinking member 140 shrinks when encountered with cold, the low-temperature shrinking member 140 is not in contact with the corresponding connecting rod member 111, or the contact friction is small, so that the low-temperature shrinking member 140 is not enough to prevent the connecting rod member 111 from sliding relative to the connecting hinge section 101. When the temperature in which the low-temperature shrinking member 140 is higher than the safe temperature, since the low-temperature shrinking member 140 expands when encountered with heat, the low-temperature shrinking member 140 is in contact with and abuts against the connecting rod member 111, and the contact friction force is sufficient to prevent the connecting rod member 111 from sliding relative to the connecting hinge section 101.

### Third Embodiment

A folding apparatus 1 in this embodiment is an improvement made on the basis of the technical solution of the second embodiment, and for the unimproved solution, the technical solution of the second embodiment continues to be used. The specific improvements are as follows: In this embodiment, a low-temperature self-locking mechanism 14 only includes a low-temperature shrinking member 140, one end of the low-temperature shrinking member 140 corresponding to a connecting rod member 111 is provided with a convex point 1410, and the connecting rod member 111 is provided with a first clamping groove 1110 and a second clamping groove 1111 corresponding to the convex point 1410.

It should be noted that, in the context of the present application, lower than the safe temperature includes the safe temperature, and higher than the safe temperature does not include the safe temperature. Or, lower than the safe temperature does not include the safe temperature, and higher than the safe temperature includes the safe temperature.

The safe temperature may be a point value or a range value, and the specific value is determined by preparing materials of the low-temperature shrinking member 140. Preparing materials may also be selected according to a use environment of a device.

### Fourth Embodiment

Also referring to FIGS. 1 to 15, this embodiment provides a flexible electronic device that uses the folding apparatus 1 in the first embodiment, the second embodiment, or the third embodiment. The folding apparatus 1 is used to support the bending of the flexible electronic device. In addition, the low-temperature self-locking protection of the flexible electronic device when the ambient temperature is lower than the safe temperature is implemented, the folding apparatus 1 is restricted from bending, and the flexible electronic device is protected. When the ambient temperature is above the safe temperature, the folding apparatus 1 removes restrictions on bending, so that the flexible electronic device can be bent normally.

Further, the flexible electronic device further includes a flexible display screen, and the folding apparatus 1 is supported below the flexible display screen.

In the description of this specification, descriptions referring to the terms “one embodiment”, “some embodiments”, “example”, “specific example”, or “some examples” and so on mean that specific features, structures, materials or characteristics described with reference to this embodiment or example are included in at least one embodiment or example of the present disclosure. In the specification, the illustrative expressions of the above terms do not necessarily refer to the same embodiments or examples. Furthermore, the specific features, structures, materials or characteristics described may be combined in any one or more embodiments or examples in a suitable manner. In addition, those skilled in the art can combine the different embodiments or examples and the features of the different embodiments or examples described in the specification without contradicting with each other.

Although the embodiments of the present disclosure have been shown and described above, it can be understood that the foregoing embodiments are exemplary and cannot be understood as limiting the present disclosure, and those of ordinary skill in the art can make changes, modifications, replacements and variations to the foregoing embodiments within the scope of the present disclosure.

What is claimed is:

1. A folding apparatus, comprising:
a hinge module;
at least one linkage mechanism connected to the hinge module and configured to drive the hinge module to bend synchronously; and
at least one low-temperature self-locking mechanism, wherein when an ambient temperature is lower than a safe temperature, the low-temperature self-locking mechanism implements self-locking matching between the linkage mechanism and the hinge module to restrict a synchronous bending of the hinge module driven by the linkage mechanism.

2. The folding apparatus according to claim 1, wherein the linkage mechanism comprises a connecting rod member, and in a process of unfolding and bending the folding apparatus, the connecting rod member slides relative to the hinge module; and
the low-temperature self-locking mechanism restricts sliding of the connecting rod member relative to the hinge module when the ambient temperature is lower than the safe temperature, so as to restrict the unfolding and bending of the folding apparatus.

3. The folding apparatus according to claim 2, wherein the low-temperature self-locking mechanism comprises a low-temperature shrinking member;
the low-temperature shrinking member has a first shape when the ambient temperature is below the safe temperature, and the first shape allows the low-temperature self-locking mechanism to restrict the sliding of the connecting rod member; and
the low-temperature shrinking member has a second shape when the ambient temperature is above the safe temperature, and the second shape allows the low-temperature self-locking mechanism to remove a restriction on the sliding of the connecting rod member.

4. The folding apparatus according to claim 3, wherein the hinge module comprises an intermediate hinge section assembly and connecting hinge sections rotatably connected to both sides of the intermediate hinge section assembly respectively;
one end of the connecting rod member is connected to the intermediate hinge section assembly, and the other end thereof slides relative to the connecting hinge section; and
the low-temperature self-locking mechanism is slidably mounted in the connecting hinge section and configured to perform self-locking matching with the connecting rod member, to restrict the sliding of the connecting rod member relative to the connecting hinge section.

5. The folding apparatus according to claim 4, wherein the low-temperature self-locking mechanism further comprises an elastic member and a linkage sliding block, the low-temperature shrinking member is disposed at one end of the linkage sliding block close to the connecting rod member, the elastic member is disposed at one end of the linkage sliding block away from the low-temperature shrinking member, and the elastic member is configured to drive the linkage sliding block to abut against the connecting rod member.

6. The folding apparatus according to claim 5, wherein one end of the low-temperature shrinking member abuts against the linkage sliding block, and the other end thereof faces the connecting rod member.

7. The folding apparatus according to claim 5, wherein one end of the linkage sliding block abutting against the connecting rod member is provided with a convex point, and a first clamping groove and a second clamping groove which are adapted to the convex point are provided in the connecting rod member along a sliding direction thereof.

8. The folding apparatus according to claim 7, wherein when the folding apparatus is bent, the convex point corresponds to the first clamping groove; and when the folding apparatus is unfolded, the convex point corresponds to the second clamping groove.

9. The folding apparatus according to claim 8, wherein the first clamping groove and the second clamping groove are respectively adapted to the shape of the convex point.

10. The folding apparatus according to claim 5, wherein the connecting hinge section is provided with a sliding groove corresponding to the linkage sliding block, and the elastic member drives the linkage sliding block to slide in the sliding groove.

11. The folding apparatus according to claim 10, wherein one end of the linkage sliding block corresponding to the elastic member is further provided with a guide member that matches the elastic member.

12. The folding apparatus according to claim 10, wherein the low-temperature self-locking mechanism further comprises a limiting member, and the limiting member is mounted on the connecting hinge section to restrict the linkage sliding block from being disengaged from the sliding groove.

13. The folding apparatus according to claim 12, wherein a middle portion of the linkage sliding block is opened with a strip-shaped guide hole, and one end of the limiting member penetrates through the strip-shaped guide hole to be connected to the bottom of the sliding groove.

14. The folding apparatus according to claim 5, wherein the low-temperature shrinking member is disposed on a step concavely disposed at one side of the linkage sliding block to abut against the linkage sliding block.

15. The folding apparatus according to claim 5, wherein the first shape of the low-temperature shrinking member is a shrunk state, and the second shape is an expanded state.

16. The folding apparatus according to claim 15, wherein the low-temperature shrinking member expands or shrinks along the sliding direction of the linkage sliding block.

17. The folding apparatus according to claim 15, wherein the low-temperature shrinking member has a first length in the sliding direction of the linkage sliding block when in the first shape; and the low-temperature shrinking member has a second length in the sliding direction of the linkage sliding block when in the second shape, and the first length is shorter than the second length.

18. The folding apparatus according to claim 4, further comprising at least one buffer mechanism, wherein the buffer mechanism is disposed at one end of the connecting rod member away from the intermediate hinge section assembly and elastically connected to the connecting hinge section.

19. The folding apparatus according to claim 18, wherein the buffer mechanism comprises a buffer connecting plate and a positioning connecting piece, the buffer connecting plate is provided with an accommodating groove in sliding fit with the connecting rod member, one end of the positioning connecting piece is rotatably mounted in the accommodating groove, and the other end thereof is rotatably connected to the connecting rod member.

20. A flexible electronic device, comprising a folding apparatus, wherein the folding apparatus comprises:
a hinge module;
at least one linkage mechanism connected to the hinge module and configured to drive the hinge module to bend synchronously; and
at least one low-temperature self-locking mechanism, wherein when an ambient temperature is lower than a safe temperature, the low-temperature self-locking mechanism implements self-locking matching between the linkage mechanism and the hinge module to restrict a synchronous bending of the hinge module driven by the linkage mechanism.
